(19) United States
(12) Patent Application Publication
(10) Pub. No.: US 2012/0227195 A1
(43) Pub. Date: Sep. 13, 2012

(54) Cleaning Compositions With Polyoxyalkylene-Oxide Capped Polyalkylene-Oxide-Polycarboxylate Comb Polymers

(76) Inventors: Koushik Mukherjee, Beijing (CN); Kenneth Nathan Price, Cincinnati, OH (US); Hemmi Akiko, Osaka (JP); Yoneda Atsuro, Osaka (JP); Michitaka Daisuke, Osaka (JP); Nakanishi Sachiko, Osaka (JP)

(21) Appl. No.: 13/328,146

(22) Filed: Dec. 16, 2011

(30) Foreign Application Priority Data
Dec. 17, 2010 (WO) CN2010/079957

(51) Int. Cl. C11D 3/37; B65D 85/00; A47L 13/17; C08G 63/66; C08G 63/664

(52) U.S. Cl. 15/104.93; 510/400; 528/366; 528/361; 206/524.7

(57) ABSTRACT

Cleaning compositions and laundry detergents comprising polyalkylene glycol-based polymers are disclosed. The polyalkylene glycol-based polymers are polyoxyalkylene-oxide capped polyalkylene-oxide-polycarboxylate comb polymers. The polyalkylene glycol-based polymer includes: a glycol-based structure unit derived from a polyalkylene glycol-based monomer, and a carboxyl-based structure unit derived from a carboxyl group-containing monomer. The glycol-based structure unit may be present at a level of 1% to 99% by mass based on 100% by mass of all structure units derived from all monomers in the polyalkylene glycol-based polymer. The carboxyl structure unit may be present at a level of 1% to 99% by mass based on 100% by mass of all the structure units derived from all the monomers in the polyalkylene glycol-based polymer. The cleaning compositions have high anti-soil redeposition ability in washing treatment and high solubility and compatibility with surfactants.

### TECHNICAL FIELD

The present invention relates to cleaning compositions, including especially fabric and home care cleaning compositions, and including especially laundry cleaning compositions. More specifically, the present invention relates to cleaning compositions comprising polyalkylene glycol-based polymers, particularly polyoxyalkylene-oxide capped polyalkylene-oxide-polycarboxylate comb polymers.

### BACKGROUND

Polyalkylene glycol-based polymers are useful polymers used in various industrial fields, and have high performance when used, for example, in dispersants, detergent compositions, and the like in aqueous environment. In the case that polyalkylene glycol-based polymers are used in aqueous environment, several influential factors such as the quality of water to be used and the interaction with other materials used in combination should be considered. Specifically, the hardness of water is different among countries or regions, and some of polyalkylene glycol-based polymers that produce various effects in aqueous environment with low water hardness may not produce sufficient effects in aqueous environment with high water hardness. When used, for example, in a detergent composition containing a surfactant, some polyalkylene glycol-based polymers may not have sufficient washing performance depending on the degree of the interaction with the surfactant.

Now, there is a water saving trend in washing treatment (e.g., use of used water in bathtub for washing treatment) with recent growing concern of consumers for environmental problems. The use of used water in bathtub for washing treatment has disadvantages such as attachment of soil components in the water to fibers in washing treatment, and condensed hardening components in the water caused by heating the water several times. Therefore, the required level of performance of preventing soil components from reattaching to fibers (referred to as anti-soil redeposition ability) in washing treatment using water with a higher hardness is much higher than before. Nowadays, concentrated liquid detergents whose surfactant content is not less than 50% are becoming popular among liquid detergents. This trend in turn has created a demand for detergent additives suitably used in such concentrated liquid detergents, that is, detergent additives with higher solubility with surfactants than conventional ones.

Conventional polyalkylene glycol-based polymers, however, do not sufficiently meet the recent needs, that is, high performance levels in aqueous environment and should be further revised so that polymers that meet the recent needs and are suitably used as higher-performance detergent additives are provided.

### SUMMARY

Cleaning compositions according to embodiments described herein comprise polyalkylene glycol-based polymers that provide improved cleaning benefits, even at lower surfactant levels or at reduced temperatures. The polyalkylene glycol-based polymers include polyalkylene oxide-capped polyalkylene oxide polycarboxylate comb polymers having a structure unit derived from a polyalkylene glycol-based monomer and a structure unit derived from a carboxyl group-containing monomer. The polyalkylene glycol-base polymers have high compatibility with surfactants and strikingly high anti-soil redeposition ability, even in water with high hardness. Embodiments are directed to fabric and home care detergent formulations and methods of use that include the polyalkyene glycol-based polymers. For example, when used in laundry detergent formulations, the polyalkyene glycol-based polymers provide improved particulate soil anti-redeposition and cleaning benefits compared to conventional polycarboxylates and modified polycarboxylates.

Example embodiments described herein are directed to cleaning compositions comprising one or more polyalkylene glycol-based polymer formed from a plurality of structure units, together defining a total mass. Of the structure units, from 1% to 90% by mass, based on the total mass, may be polyalkylene glycol-based structure units having formula (II):

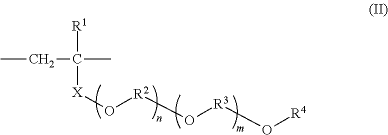

where R¹ is —H or —CH₃; X is —CH₂—, —CH₂CH₂—, or a direct bond; n is from 1 to 300 and represents an average addition number of moles of an oxyalkylene group (—R²—O—); each R² is independently selected from C₂₋₂₀ alkylene groups; m is from 1 to 20 and represents an average addition number of moles of an oxyalkylene group (—R³—O—); each R³ is independently selected from C₃₋₄ alkylene groups; and R⁴ is —H, a C₁₋₂₄ alkyl group, or a C₆₋₂₄ aryl group. Furthermore, of the structure units, from 10% to 99% by mass, based on the total mass, may be carboxyl structure units each derived from a carboxyl group-containing monomer.

Optionally, additional structure units may be present in the polyalkylene glycol-based polymers. The additional structure units each are derived from additional monomers having at least one unsaturated double bond and characterized as neither a polyalkylene glycol-based monomer nor a carbosyl group-containing monomer.

In example embodiments, cleaning compositions comprising the polyalkylene glycol-based polymers may further comprise a surfactant system containing one or more surfactant and, optionally, one or more co-surfactant.

In further example embodiments, the cleaning compositions may be incorporated into a cleaning implement comprising a nonwoven substrate.

These and other features, aspects, and advantages of the present invention will become better understood with reference to the following description and appended claims.

### DETAILED DESCRIPTION

Features and advantages of the invention now will be described with occasional reference to specific embodiments. However, the invention may be embodied in different forms and should not be construed as limited to the embodiments set forth herein. Rather, these embodiments are provided so that this disclosure will be thorough and complete and will fully convey the scope of the invention to those skilled in the art.

According to example embodiments, a cleaning composition comprises one or more polyalkylene glycol-based polymer formed from a plurality of structure units together defining a total mass of the polyalkyene glycol-based polymer. The structure units are chosen such that from 1% to 90% by mass of the plurality of structure units, based on the total mass, are polyalkylene glycol-based structure units, as described below in detail. In preferred embodiments, the polyalkylene glycol-based structure units may be derived from polyalkylene glycol-based monomers, as described below. The structure units further are chosen such that from 10% to 99% by mass of the plurality of structure units, based on the total mass, are carboxyl structure units each derived from a carboxyl group-containing monomer, as described below in detail. Additional monomer units, also described below, may be present in the polyalkylene glycol-based polymers. As used herein, the term “polyalkylene glycol-based polymer” is intended to include polymers having a polyalkylene glycol chain, and the term “polyalkylene glycol-based monomer” is intended to include monomers having a polyalkylene glycol chain.

In preferred embodiments, each polyalkylene glycol-based polymer in the cleaning composition contains a polyalkylene glycol-based structure unit derived from a polyalkylene glycol-based monomer having the formula (I):

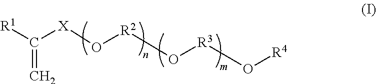

where R¹ is —H or a methyl group; X is —CH₂—, —CH₂CH₂—, or a direct bond; n is from 1 to 300 and represents an average addition number of moles of the oxyalkylene group (—R²—O—); each R² is independently selected from C₂₋₂₀ alkylene group and, as such, each group R² may be the same as or different from each other; m is from 1 to 20 and represents an average addition number of moles of the oxyalkylene group (—R³—O—); each R³ is independently selected from C₃₋₄ alkylene groups and, as such, each group R³ may be the same as or different from each other; and R⁴ is —H, a C₁₋₂₄ alkyl group, or a C₆₋₂₄ aryl group.

The structure of the polyalkylene glycol-based monomer shown having formula (I) includes a C₃₋₄ oxyalkylene group near the end of a side chain in the polyalkylene glycol-based polymer. This structure provides strikingly high anti-soil redeposition ability against hydrophobic soils and also provides high compatibility with surfactants. Owing to high compatibility with surfactants, when used in a liquid detergent or the like, the polyalkylene glycol-based polymer of the present invention has good temporal stability (stability against phase separation) in the detergent composition or the like.

In the formula (I), R¹ represents —H or —CH₃, and is preferably —CH₃. Likewise, X represents a methylene group, an ethylene group, or a direct bond, is preferably a methylene group or an ethylene group, and more preferably is an ethylene group. For example, the structure represented by CH₂═CH—X—O— is the structure represented by CH₂═CH—O— when X is a direct bond. When used in a detergent composition, the polyalkylene glycol-based polymers derived from monomers in which X in the formula (I) is a methylene group, an ethylene group, or a direct bond have stable high washing performance, clay dispersibility, anti-soil redeposition ability, and the like under neutral to weak alkaline conditions, which are suitable for washing treatment.

For example, comparative monomers having an ester bond connecting an unsaturated double bond and a polyalkylene glycol chain are exemplified as comparative monomers having formula (I), but in which X is not a methylene group, an ethylene group, or a direct bond. The comparative monomers or comparative polymers obtained by polymerizing these comparative monomers undergo hydrolysis of the ester bond during the synthesis or polymerization of the comparative monomers, or while in use. Typically, these comparative monomers have high molecular weights and therefore will significantly influence the characteristics of comparative polymers obtained by polymerizing these comparative monomers, even if only a small portion of the ester bonds in the comparative monomers are hydrolyzed. That is, these comparative polymers will have variations in a number of their characteristics.

In contrast, the polyalkylene glycol-based monomer in which X in the formula (I) is a methylene group, an ethylene group, or a direct bond, is highly stable against pH and temperature variations. Therefore, the polyalkylene glycol-based monomer and the polyalkylene glycol-based polymer obtained by polymerizing the polyalkylene glycol-based monomer are hardly decomposed during the synthesis or polymerization of the monomer or while in use, for example, even under stringent conditions in detergent production.

The polyalkylene glycol-based monomer is more copolymerizable when X is an ethylene group than when the polyalkylene glycol-based monomer contains an unsaturated double bond such as an allyl-ether bond or a vinyl-ether bond. Owing to high copolymerizability, variations in the amount of residual monomers after polymerization are reduced, which leads to reduced variations in the performance of the resulting polyalkylene glycol-based polymer. For these reasons, when X in the formula (I) is an ethylene group, the polyalkylene glycol-based polymer has particularly high performance and is substantially free from the above problems when used in a detergent and the like. In addition, variations of the product quality can be reduced.

Each R² in the formula (I) is independently selected from C₂₋₂₀ alkylene groups. As such, each group R² may be the same as or different from other groups R². To improve the polymerizability of the polyalkylene glycol-based monomer, R² is preferably a C₂₋₄ alkylene group, more preferably C₂₋₃ alkylene group, and further more preferably a C₂ alkylene group. Specifically, C₂₋₄ alkylene groups such as ethylene groups, propylene groups, and butylene groups are preferable, and C₂₋₃ alkylene groups such as ethylene groups and propylene groups are more preferable. Among these, the C₂ alkylene group, the ethylene group, is particularly preferable.

The groups R² may be all of the same structure or may be of two or more different structures. Preferably, ethylene groups constitute from 80 mol. % to 100 mol. % of all groups R² (totaling 100 mol. %) in the formula (I), more preferably from 90 mol. % to 100 mol %, and further more preferably 100 mol % of all groups R² in the formula (I). When the groups R² are of two or more different structures, the added oxyalkylene groups each represented by —R²—O— may be arranged in any manner such as randomly, in blocks, or alternatingly.

In the formula (I), each R³ is independently selected from C₃₋₄ alkylene groups. As such, each group R³ may be the same as or different from other groups R³. Among these, isopropylene groups (i.e., —CH₂CH(CH₃)— or —CH(CH₃)CH₂—) and isobutylene groups (i.e., —CH₂CH(C₂H₅)— or —CH(C₂H₅)CH₂—) are particularly preferable. When R³ is selected from the group consisting of these structures, the polyalkylene glycol-based monomer can be produced with minimal impurities, and the anti-soil redeposition ability of the polyalkylene glycol-based polymer may be improved accordingly.

The groups R³ may be all of the same structure or may be of two or more different structures. Preferably, C₃ alkylene groups constitute from 80 mol. % to 100 mol % of all groups R³ (totaling 100 mol. %) in the formula (I), more preferably from 90 mol. % to 100 mol %, and further more preferably 100 mol % of all groups R³ in the formula (I). When the groups R³ are of two or more different structures, the added oxyalkylene groups each represented by —R³—O— may be arranged in any manner such as a randomly, in blocks, or alternatingly.

In the formula (I), groups R⁴ may be —H, a C₁₋₂₄ alkyl group, or a C₆₋₂₄ aryl group. When R⁴ is an alkyl group or aryl group, one or more hydrogen atoms in R⁴ may or may not be substituted with other organic group(s), provided that the total number of carbon atoms is within the above-mentioned range. Examples of the other organic groups include alkyl groups (in this case, when R⁴ is an alkyl group, the alkyl group with substitutent(s) is regarded as an unsubstituted alkyl group as a whole), aryl groups, alkenyl groups, alkoxy groups, hydroxyl group, acyl groups, ether groups, amide groups, ester groups, and ketone groups.

Among the above examples, R⁴ is preferably —H, a C₁₋₁₂ alkyl group, or a C₆₋₁₂ aryl group, more preferably —H, a C₁₋₈ alkyl group, or a C₆₋₈ aryl group, and further more preferably —H, a C₁₋₄ alkyl group, or a C₆₋₈ aryl group. These structures in the position of R⁴ enable the polyalkylene glycol-based monomer to be produced with high yield and, thus, may improve the polymerizability of the monomer and the purity of the resulting polymer. In addition, the anti-soil redeposition ability of the resulting polymer may be improved.

Specifically well-suited example of groups R⁴ include, but are not necessarily limited to, —H; alkyl groups such as methyl group, ethyl group, isopropyl group, n-propyl group, n-butyl group, isobutyl group, octyl group, lauryl group, stearyl group, cyclohexyl group, and 2-ethylhexyl group; aryl groups such as phenyl group, benzyl group, phenethyl group, 2,3- and 2,4-xylyl groups, mesityl group, and naphthyl group; and groups obtained by substituting one or more hydrogen atom(s) in the above groups with alkoxy groups, carboxyester groups, amino groups, amide groups, and hydroxyl groups (e.g., hydroxyethyl group, hydroxypropyl group). R⁴ is more preferably —H or a methyl group. Hydrogen and methyl may provide a more simplified process to produce the polyalkylene glycol-based monomer with fewer impurities. R⁴ is further more preferably —H.

In the formula (I), the subscript n represents an average addition number of moles of the oxyalkylene group (—R²—O—). The subscript n typically is from 1 to 300. To further improve performance of the polyalkylene glycol-based polymer in aqueous environment, n is preferably an integer from 2 to 100, and more preferably an integer from 3 to 55. The subscript m represents an average addition number of moles of the oxyalkylene group (—R³—O—). The subscript m typically is from 1 to 20. To further improve performance of the polyalkylene glycol-based polymer in aqueous environment, m is preferably an integer from 2 to 15, and more preferably an integer from 3 to 10.

Out of 100 mol. % of all the oxyalkylene groups represented by (—R²—O—) and (—R³—O—) in the formula (I) in the polyalkylene glycol-based monomer, C₃₋₄ oxyalkylene groups preferably constitute from 1 mol. % to 90 mol. %, more preferably from 3 mol. % to 80 mol %, and further more preferably 5 mol. % to 50 mol %. With C₃₋₄ oxyalkylene groups within the above range, the performance of the polyalkylene glycol-based polymer in aqueous environment may be improved, and the washing performance against hydrophobic soils may be improved also. In addition, with C₃₋₄ oxyalkylene groups within this range, the compatibility of the polyalkylene glycol-based polymer with liquid detergents may be improved.

Each polyalkylene glycol-based polymer in the cleaning composition contains polyalkylene glycol-based structure units. In preferred embodiments, the polyalkylene glycol-based structure units are derived from polyalkylene glycol-based monomers having formula (I). However, it will be understood that polyalkylene glycol-based structure units may be derived from other sources as well and that the polyalkylene glycol-based polymers described herein are by no means limited to containing polyalkylene glycol-based structure units derived from polyalkylene glycol-based monomers having formula (I).

In general, the polyalkylene glycol-based structure units of the polyalkylene glycol-based polymers are represented by the formula (II):

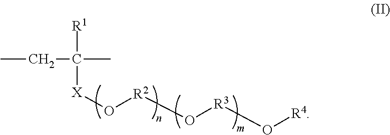

The polyalkylene glycol-based structure units having formula (II) are distinguished from the polyalkylene glycol-based monomers having formula (I) in that a double bond between carbons is converted to two polymerizable single bonds. In the formula, R¹, X, R², R³, R⁴, n, and m are defined the same as R¹, X, R², R³, R⁴, n, and m in the formula (I), respectively, and all have the same preferred values.

As used herein, the phrase “the polyalkylene glycol-based polymer contains polyalkylene glycol-based structure units derived from the polyalkylene glycol-based monomer” means that the final polyalkylene glycol-based polymer product contains a polyalkylene glycol-based structure unit represented by the formula (II). Specifically, the term “the polyalkylene glycol-based structure unit derived from the polyalkylene glycol-based monomer” is intended to include structure units introduced in a step before or after the polymerization reaction, such as structure units added by introducing side chains of specific structures after the main chain structure of the polyalkylene glycol-based polymer is formed by copolymerization, in addition to structure units introduced in the polyalkylene glycol-based polymer by synthesizing the polyalkylene glycol-based monomer and then copolymerizing the polyalkylene glycol-based monomer and other additional monomers, described below. The polyalkylene glycol-based structure units in the polyalkylene glycol-based polymer may be all of the same structure or may be of two or more different structures.

The polyalkylene glycol-based polymer contains the structure unit (a) at a level of from 1% to 90% by mass, based on the total mass, or 100% by mass of all structure units derived from all monomers in the polyalkylene glycol-based polymer (i.e., the polyalkylene glycol-based structure unit, the carboxyl group-containing structure units (described below), and the additional structure units (described below)). With the polyalkylene glycol-based structure unit at a level within this range, the polyalkylene glycol-based polymer produces excellent interaction with soil components when used as a detergent builder. As a result, soil component particles involved in the interaction with the polymer are well dispersed, and thus the anti-soil redeposition ability is provided. In addition, the compatibility with surfactants may be improved. The level of the polyalkylene glycol-based structure unit is preferably 5% to 80% by mass, more preferably 10% to 70% by mass, and further more preferably 15% to 65% by mass.

The process for preparing the polyalkylene glycol-based monomer is not particularly limited, and any suitable preparation process may be employed. Examples of simple preparation processes include: a process including sequentially adding a C₂ alkylene oxide and a C₃₋₄ alkylene oxide to hydroxyl groups of an unsaturated alcohol such as (meth)allyl alcohol, isoprenol, ethylene glycol monovinyl ether, or butylene glycol monovinyl ether; and a process including reacting an unsaturated halogen compound such as (meth)allyl chloride or isoprenyl chloride with a monoalkoxy alkylene glycol. The addition reaction of an alkylene oxide to hydrogen groups may be carried out under commonly known reaction conditions practiced by those skilled in the art.

### Carboxyl Group-Containing Monomer and Structure Unit

The plurality of structure units in the polyalkylene glycol-based polymer further comprises carboxyl group-containing structure units derived from one or more carboxyl group-containing monomer. The carboxyl group-containing monomer is a monomer containing (1) an unsaturated double bond and (2) a carboxyl group or a carboxylate salt. Specific examples thereof include unsaturated monocarboxylic acid-based monomers such as unsaturated monocarboxylic acids (e.g., acrylic acid, methacrylic acid, crotonic acid, α-hydroxyacrylic acid, α-hydroxymethylacrylic acid, derivatives of these), and salts of these; and unsaturated dicarboxylic acid-based monomers such as unsaturated dicarboxylic acids (e.g., itaconic acid, fumaric acid, maleic acid, citraconic acid, 2-methyleneglutaric acid), and salts of these.

Any unsaturated dicarboxylic acid-based monomer may be used, provided that it contains an unsaturated group and two carboxyl groups in the molecular structure. Suitable examples of unsaturated dicarboxylic acids include maleic acid, itaconic acid, citraconic acid, and fumaric acid; monovalent metal salts, divalent metal salts, ammonium salts, and organic ammonium salts (organic amine salts) of the above acids; and anhydrides of the above examples. Among these examples, the carboxyl group-containing monomer is preferably acrylic acid, an acrylate, maleic acid, or a maleate because these may improve the anti-soil redeposition ability of the resulting polyalkylene glycol-based polymer. It is more preferable that the carboxyl group-containing monomers consist essentially of acrylic acid or an acrylate.

Suitable examples of salts of the unsaturated monocarboxylic acids and unsaturated dicarboxylic acids include metal salts, ammonium salts, and organic amine salts of these acids. Examples of the metal salts include monovalent alkali metal salts such as sodium salts, lithium salts, and potassium salts; alkaline-earth metal salts such as magnesium salts and calcium salts; and salts of other metals such as aluminum salts and iron salts. Examples of the organic amine salts include alkanolamine salts such as monoethanolamine salts, diethanolamine salts, and triethanolamine salts; alkylamine salts such as monoethylamine salts, diethylamine salts, and triethylamine salts; and organic amine salts such as polyamines including ethylenediamine salts and triethylenediamine salts. Ammonium salts, sodium salts, and potassium salts are preferable among these because they remarkably improve the anti-soil redeposition ability of the resulting polymer. Sodium salts are more preferable. In addition to the above examples, examples of the carboxyl group-containing monomer include half esters of unsaturated dicarboxylic acids and C₁₋₂₂ alcohols, half amides of unsaturated dicarboxylic acids and C₁₋₂₂ amines, half esters of unsaturated dicarboxylic acids and C₂₋₄ glycols, and half amides of maleamic acid and C₂₋₄ glycols.

In the carboxyl group-containing structure unit derived from the carboxyl group-containing monomer, the unsaturated double bond in the monomer is converted to two polymerizable single bonds. Thus, the phrase “the polyalkylene glycol-based polymer contains the structure unit (b) derived from the carboxyl group-containing monomer (B)” means that the final polyalkylene glycol-based polymer product contains carboxyl group-containing structure units in which the unsaturated double bond in the carboxyl group-containing monomer is converted to two polymerizable single bonds. The carboxyl group-containing structure units in the polyalkylene glycol-based polymer may be all of the same structure or may be of two or more different structures.

The polyalkylene glycol-based polymer contains carboxyl group-containing structure units at a level of from 10% to 99% by mass based on the total mass, 100% by mass of all structure units derived from all monomers in the polyalkylene glycol-based polymer (i.e., the polyalkylene glycol-based structure unit, the carboxyl group-containing structure units, and the additional structure units (described below)). With the carboxyl group-containing structure units at a level within this range, the polyalkylene glycol-based polymer is highly soluble to water when used as a detergent builder. As a result, soil component particles involved in the interaction with the polyalkylene glycol-based structure unit in the polyalkylene glycol-based polymer are well dispersed. Thereby, the anti-soil redeposition ability is provided. In addition, compatibility with surfactants may be improved. The level of the carboxyl group-containing structure unit is preferably 20% to 95% by mass, more preferably 30% to 90% by mass, and further more preferably 35% to 85% by mass, based on the total mass.

When the mass ratio (% by mass) of the carboxyl group-containing structure units derived from the carboxyl group-containing monomers to all the structure units derived from all the monomers in the polyalkylene glycol-based polymer is calculated, the carboxyl group-containing structure unit is treated as the corresponding acid. In the case of the carboxyl group-containing structure unit —CH₂—CH(COONa)— derived from sodium acrylate, for example, the mass ratio (% by mass) of the carboxyl group-containing structure unit derived from the corresponding acid (acrylic acid), that is, the mass ratio (% by mass) of the structure unit —CH₂—CH(COOH)—, is calculated. When the mass ratio (% by mass) of the carboxyl group-containing monomer to all the monomers in the polyalkylene glycol-based polymer is calculated, the carboxyl group-containing monomer is similarly treated as the corresponding acid. For example, to determine the mass ratio of sodium acrylate, the mass ratio (% by mass) of the corresponding acid (acrylic acid) is calculated instead.

### Additional Monomer

The polyalkylene glycol-based polymer optionally may contain additional structure unit(s) derived from additional monomer(s). The additional monomers are monomers not classified as being neither polyalkylene glycol-based monomers nor carboxyl group-containing monomers. The additional structure units in the polyalkylene glycol-based polymer may be all of the same structure or may be of two or more different structures.

The additional monomer(s) are not particularly limited, provided that they are copolymerizable with the polyalkylene glycol-based monomers and the carboxyl group-containing monomers. The additional monomer(s) are appropriately selected to provide a desired effect. Specific examples thereof include sulfonic acid group-containing monomers such as vinylsulfonic acid, (meth)allylsulfonic acid, isoprenesulfonic acid, 3-allyloxy-2-hydroxypropanesulfonic acid, and acrylamido-2-methylpropanesulfonic acid, and salts of these; polyalkylene glycol chain-containing monomer such as (meth)acrylates of alkoxy alkylene glycols and monomers obtained by adding alkylene oxides to unsaturated alcohols other than the polyalkylene glycol-based monomers (e.g., (meth)allyl alcohol and isoprenol); amino group-containing monomers such as vinyl aromatic compound-based monomers having a heterocyclic aromatic hydrocarbon group (e.g., vinyl pyridine, vinyl imidazole), dialkylaminoalkyl(meth)acrylates (e.g., dimethylaminoethyl acrylate, dimethylaminoethyl methacrylate, and dimethylaminopropyl acrylate), dialkylaminoalkyl(meth)acrylamides (e.g., dimethylaminoethyl acrylamide, dimethylaminoethyl methacrylamide, and dimethylaminopropyl acrylamide); allylamines including diallylamine and diallylalkylamines (e.g., diallyldimethylamine), and quaternized compounds of these; N-vinyl monomers such as N-vinylpyrrolidone, N-vinylformamide, N-vinylacetamide, N-vinyl-N-methylformamide, N-vinyl-N-methylacetamide, and N-vinyloxazolidone; amide-containing monomers such as (meth)acrylamide, N,N-dimethylacrylamide, and N-isopropylacrylamide; hydroxyl group-containing monomers such as (meth)allyl alcohol and isoprenol; alkyl(meth)acrylate-based monomers such as butyl(meth)acrylate, 2-ethylhexyl(meth)acrylate, and dodecyl(meth)acrylate; hydroxyalkyl(meth)acrylate-based monomers such as hydroxyethyl(meth)acrylate, 2-hydroxyethyl(meth)acrylate, hydroxybutyl(meth)acrylate, 2-hydroxybutyl(meth)acrylate, 4-hydroxybutyl(meth)acrylate, α-hydroxymethylethyl(meth)acrylate, hydroxypentyl(meth)acrylate, hydroxyneopentyl(meth)acrylate, and hydroxyhexyl(meth)acrylate; vinylaryl monomers such as styrene, indene, and vinylaniline; and other monomers such as isobutylene, and vinyl acetate.

Quaternized compounds can be obtained by the reaction between any amino group-containing additional monomers and common quaternizing agents. Examples of quaternizing agents include alkyl halides and dialkyl sulfates. Example salts of quaternized compounds include hydrochlorides and organic acid salts.

In the additional structure unit(s) derived from the additional monomer(s), an unsaturated double bond in the additional monomer(s) is converted to two polymerizable single bonds. Thus, the phrase “the polyalkylene glycol-based polymer contains additional structure unit(s) derived from additional monomer(s)” means that the final polyalkylene glycol-based polymer product contains structure unit(s) in which an unsaturated double bond in the additional monomer(s) is converted to two polymerizable single bonds.

When the polyalkylene glycol-based polymer contains one or more of the optional additional structure unit(s) derived from the additional monomer(s), the additional structure unit(s) are preferably present at a level of from greater than 0% (i.e., at least one additional monomer is present, but the overall percentage may be negligble) to 60% by mass, based on the total mass, 100% by mass representing all the structure units derived from all the monomers (i.e., the total amount of the polyalkylene glycol-based structure units, the carboxyl group-containing structure units, and the additional structure units) in the polyalkylene glycol-based polymer, and more preferably from greater than 0% to 50% by mass.

When an additional structure unit is an amino group-containing monomer, the mass ratio of the additional structure unit to all the structure units derived from all the monomers, and the mass ratio of the amino group-containing monomer to all the monomers, are determined by treating the amino group-containing additional structure unit and the corresponding monomer as the corresponding unneutralized amine. For example, when the additional monomer is vinylamine hydrochloride, the mass ratio (% by mass) of its corresponding unneutralized amine, that is, the mass ratio of vinylamine, is calculated instead.

Similarly, the mass ratios (% by mass) of quaternized amino group-containing additional monomers and additional structure units derived from the quaternized amino group-containing monomers are calculated without counting the mass of counteranion.

Similarly, when an additional structure unit derived from an acid group-containing monomer is contained as the additional structure unit, the mass ratio (% by mass) of the additional structure unit to all the structure units derived from all the monomers in the polyalkylene glycol-based polymer is calculated by treating the additional structure unit as the corresponding acid. The mass ratio (% by mass) of the acid group-containing additional monomer to all the monomers in the polyalkylene glycol-based polymer is calculated by treating the acid group-containing additional monomer as the corresponding acid.

### Polymer Characteristics and Properties of Polyalkylene Glycol-Based Polymer

In the polyalkylene glycol-based polymer, the polyalkylene glycol-base structure units, the carboyl group-containing structure units, and, optionally, the additional structure unit(s) are introduced at specific levels, as described above. These structure units may be arranged randomly or in blocks. The weight-average molecular weight (M_{W}) of the polyalkylene glycol-based polymer is not particularly limited and can be appropriately selected. Specifically, the weight-average molecular weight of the polyalkylene glycol-based polymer is preferably from 2,000 to 200,000, more preferably from 3,000 to 100,000, further more preferably from 4,000 to 60,000, and still further more preferably from 4,000 to 20,000. With weight average molecular weights in this range, the anti-soil redeposition ability may be improved. The number-average molecular weight (M_{N}) of the polyalkylene glycol-based polymer is preferably from 1,000 to 100,000, more preferably from 1,500 to 50,000, further more preferably from 2,000 to 25,000, and still further more preferably from 2,000 to 8,000. With number average molecular weights in this range, the anti-soil redeposition ability may be improved.

The weight average molecular weight and number average molecular weight used herein may be determined by GPC (gel permeation chromatography) and can be determined with the device under the measurement conditions as described in Examples below.

The polyalkylene glycol-based polymer has high anti-soil redeposition ability. The anti-soil redeposition ratio of the polyalkylene glycol-based polymer is preferably not less than 59.3%, and more preferably not less than 59.5%. The anti-soil redeposition ratio can be measured by the procedure described in Examples below.

### Polyalkylene Glycol-Based Polymer Compositions

The polyalkylene glycol-based polymer may be present with other components, such as in a polyalkylene glycol-based polymer composition. Examples of components other than the polyalkylene glycol-based polymer include residues of polymerization initiators, residual monomers, by-products of polymerization, and water. Such a polyalkylene glycol-based polymer composition may contain one or more of these components. The polyalkylene glycol-based polymer is preferably present at a level of 1% to 100% by mass based on 100% by mass of the whole polyalkylene glycol-based polymer composition. A preferred example of the polyalkylene glycol-based polymer composition is a polyalkylene glycol-based polymer composition containing 40% to 60% by mass of the polyalkylene glycol-based polymer and 40% to 60% by mass of water.

The polyalkylene glycol-based polymers advantageously comprise polyalkylene oxides in the form of a mixed polyalkylene oxide system providing hydrophilicity and hydrophobicity in defined degrees. Preferred embodiments of the polyalkylene glycol-based polymers comprise a polyacrylate/maleate backbone (formed from the carboxyl group-containing monomers) having comb tentacles. The comb tentacles are formed from polyethylene oxide capped by oligo- or poly-propylene oxide moieties. The terminal propylene oxide group oxygen atom is preferably replaced with H, but also may be replaced with an alkyl or aryl group. The polyalkylene glycol-based polymers may optionally contain polyethylene oxide tentacles not capped by polypropylene oxide moieties. Without wishing to be bound by theory, it is believed that the polypropylene oxide (PPO) capping units advantageously provide a type of hydrophobic capping group for polycarboxylate/PEG comb polymers. The degree of hydrophobicity of the capping unit is less than that of simple alkyl or aryl groups. Moreover, the PPO capping unit may provide a degree of steric bulkiness and hydrogen-bond acceptor properties useful for soil, fabric, and surfactant interactions. Furthermore, in especially preferred embodiments, the PPO capping moeities are distal to the polycarboxylate backbone. In one mode of interaction, the polycarboxylate moieties can bind to calcium, either in solution or as bridging units between clay platelets, while the PEO-PPO tentacles extend into water solution and terminally interact with surfactant monomers or micelles. In another mode of interaction, the PPO capping groups may anchor the polymer onto soil or fabric surfaces, with the polycarboxylate main chain providing charge stabilization. The charge stabilization may provide a fabric with negative charges (presented to bulk solution) that act as soil repellancy motifs. The charge stabilization also may increase the suspendability of clay and other particulate matter.

### Process for Producing Polyalkylene Glycol-Based Polymer

The polyalkylene glycol-based polymers can be produced by copolymerizing monomers including the polyalkylene glycol-based monomer and the carboxyl group-containing monomer, and optionally including additional monomer(s) at specific ratios.

In example processes for producing the polyalkylene glycol-based polymers, the polyalkylene glycol-based monomer may be added at a level of from 1% to 90% by mass based on 100% by mass of all the monomers (polyalkylene glycol-based monomers, carboxyl group-containing monomers, and optional additional monomers). The carboxyl group-containing monomers may added at a level of from 10% to 99% by mass, based on 100% by mass of all the monomers.

If the polyalkylene glycol-based monomer is added at a level of less than 1% by mass, the polymer is less likely to adsorb on hydrophobic soils, therefore the anti-soil redeposition ability and washing performance against hydrophobic soils will be low. If the carboyl group-containing monomer is added at a level of less than 10% by mass, the polymer is less likely to adsorb on hydrophilic soils, therefore the anti-soil redeposition ability and washing performance against hydrophilic soils will be low. As such, the polyalkylene glycol-based monomer is preferably used at a level of from 5% to 80% by mass in the polymerization, and more preferably at a level of from 10% to 70% by mass, and further more preferably at a level of from 15% to 65% by mass. The carboxyl group-containing monomer is preferably used at a level of from 20% to 95% by mass in the polymerization, more preferably at a level of from 30% to 90% by mass, and further more preferably at a level of from 35% to 85% by mass.

The additional monomer(s) may be added at a level of from greater than 0% (i.e., at least one additional monomer is added, but the overall percentage may be negligible) to 50% by mass based on 100% by mass of all the monomers (polyalkylene glycol-based monomers, carboxyl group-containing monomers, and optional additional monomers), and more preferably at a level of from greater than 0% to 10% by mass, further more preferably at a level of from greater than 0% to 5% by mass, and still further more preferably at 0% by mass (i.e., no intentionally added additional monomers).

The polyalkylene glycol-based polymer may be produced by any polymerization method, and a known polymerization method or a modified method thereof can be used. Examples of polymerization methods include radical polymerization. Specific examples of polymerization methods include water-in-oil emulsion polymerization, oil-in-water emulsion polymerization, suspension polymerization, dispersion polymerization, precipitation polymerization, solution polymerization, aqueous solution polymerization, and bulk polymerization. Among these polymerization methods, solution polymerization is preferable, because it is a highly safe method and requires only low production cost (polymerization cost).

In the production process, the polymerization conditions such as polymerization temperature are appropriately determined based on factors such as the polymerization method, solvents, and polymerization initiators. The polymerization temperature is preferably not lower than 25° C. to 200° C., and more preferably 50° C. to 150° C., further more preferably 60° C. to 120° C., and still further more preferably 80° C. to 110° C. At too low polymerization temperatures, the resulting polymer will have too high weight average molecular weight and larger amounts of impurities will generate.

The polyalkylene glycol-based polymer produced by the above process has high performance when used in aqueous environment. In addition, the polymer has high hard water resistance, washing performance, anti-soil redeposition ability, clay dispersability, and interaction with surfactants and therefore has particularly high performance when used in dispersants, detergent builders, detergent compositions, detergents, and water treatment agents.

### Usage of Polyalkylene Glycol-Based Polymer and Polyalkylene Glycol-Based Polymer Composition

The polyalkylene glycol-based polymer (or polyalkylene glycol-based polymer composition) can be used as a coagulant, flocculating agent, printing ink, adhesive, soil control (modification) agent, fire retardant, skin care agent, hair care agent, additive for shampoos, hair sprays, soaps, and cosmetics, anion exchange resin, dye mordant, and auxiliary agent for fibers and photographic films, pigment spreader for paper making, paper reinforcing agent, emulsifier, preservative, softening agent for textiles and paper, additive for lubricants, water treatment agent, fiber treating agent, dispersant, additive for detergents, scale control agent (scale depressant), metal-ion sealing agent, viscosity improver, binder of any type, emulsifier, and the like. When used as a detergent builder, the polyalkylene glycol-based polymer (or polyalkylene glycol-based polymer composition) can be added to detergents for various usages such as detergents for clothes, tableware, cleaning, hair, bodies, toothbrushing, and vehicles.

### Fiber Treating Agent

The polyalkylene glycol-based polymer (or polyalkylene glycol-based polymer composition) can be used in fiber treating agents. Such fiber treating agents contain the polyalkylene glycol-based polymer (or polyalkylene glycol-based polymer composition) and at least one selected from the group consisting of dyeing agents, peroxides, and surfactants. In fiber treating agents, the polyalkylene glycol-based polymer preferably constitutes 1 to 100% by weight, and more preferably 5 to 100% by weight of the total amount. In addition, any suitable water soluble polymer may be included within a range of not affecting the performance or effect of this polymer.

An example of the composition of such a fiber treating agent is described below. The fiber treating agent can be used in steps of scouring, dyeing, bleaching and soaping in fiber treatment. Examples of dyeing agents, peroxides, and surfactants include those commonly used in fiber treating agents.

The blending ratio between the polyalkylene glycol-based polymer and at least one selected from the group consisting of dyeing agents, peroxides, and surfactants is determined based on the amount of the purity converted fiber treating agent per part by weight of the polyalkylene glycol-based polymer. In a suitable example of a composition that is used as a fiber treating agent to provide improved degree of whiteness, color uniformity, and dyeing fastness of textiles, at least one selected from the group consisting of dyeing agents, peroxides, and surfactants is preferably used at a ratio of 0.1 to 100 parts by weight per part by weight of the polyalkylene glycol-based polymer.

The fiber treating agent can be used for any suitable fibers including cellulosic fibers such as cotton and hemp, synthetic fibers such as nylon and polyester, animal fibers such as wool and silk thread, semisynthetic fibers such as rayon, and textiles and mixed products of these. For a fiber treating agent used in a scouring step, an alkali agent and a surfactant are preferably used with the polyalkylene glycol-based polymer. For a fiber treating agent used in a bleaching step, a peroxide and a silicic acid-containing agent such as sodium silicate as a decomposition inhibitor for alkaline bleaches are preferably used with the polyalkylene glycol-based polymer.

### Detergent Builder

The polyalkylene glycol-based polymer (or polyalkylene glycol-based polymer composition) can be used as a detergent builder also. The detergent builder can be added to detergents for various usages such as detergents for clothes, tableware, cleaning, hair, bodies, toothbrushing, and vehicles.

### Detergent Composition

The polyalkylene glycol-based polymers (or polyalkylene glycol-based polymer compositions) can be also used in detergent compositions. A key advantage of the polyalkylene glycol-based polymer is that the polyalkylene oxide is a mixed polyakylene oxide system providing a plurality of hydrophilicity and hydrophobicity levels in defined degrees. For example, key examples of the polyalkylene glycol-based polymer are polymers comprising a polyacrylate/maleate backbone, with comb tentacles involving polyethylene oxide capped by oligo-propylene or poly-propylene oxide moeities. The terminal propylene oxide group oxygen atom is usually hydrogen, but may be optionally be capped by an alkyl or aryl group. The polymers may optionally contain polyethylene oxide tentacles not capped by polypropylene oxide moieties.

Without wishing to be bound by theory, it is believed the polypropylene oxide (PPO) capping units provide a hydrophobic capping group for polycarboxylate/PEG comb polymers, wherein the degree of hydrophobicity of the capping unit is less than that of simple alkyl or aryl groups, and wherein the PPO capping unit provides a degree of steric bulkiness and hydrogen bond acceptor properties useful for soil, fabric, and surfactant interactions. Furthermore, it is important that the PPO capping moeities be distal to the polycarboxylate backbone. In one mode of interaction, the polycarboxylate moieties can bind to calcium either in solution or as bridging units between clay platelets, with the PEO-PPO tentacles extended into water solution and terminally interacting with surfactant monomers or micelles. In still another mode of interaction, the PPO capping groups anchor the polymer onto soil or fabric surfaces with the polycarboxylate main chain acts to provide charge stabilization to either provide a fabric with negative charges (presented to bulk solution), which act as soil repellancy motifs, or to increase the suspendability of clay and other particulate matter via charge stabilization mechanisms.

In detergent compositions, the amount of the polyalkylene glycol-based polymer is not particularly limited, and the polyalkylene glycol-based polymer is preferably used at a level of 0.1% to 15% by mass, more preferably 0.3% to 10% by mass, and further more preferably 0.5% to 5% by mass based on 100% by mass of the total amount. At levels within this range, the polyalkylene glycol-based polymer provides excellent detergent builder performance.

It is to be understood that the concept of the “detergent compositions” includes detergents used only for specific usages such as bleaching detergent in which the performance delivered by one component is improved, in addition to synthetic detergents of household detergents, detergents for industrial use such as detergents used in the textile industry and hard surface detergents.

When the detergent compositions are in the form of a liquid, the water content of the liquid detergent compositions is preferably 0.1% to 75% by mass, more preferably 0.2% to 70% by mass, further more preferably 0.5% to 65% by mass, still further more preferably 0.7% to 60% by mass, particularly preferably 1% to 55% by mass, and more particularly preferably 1.5% to 50% by mass.

When the detergent compositions are in the form of a liquid, the kaolin turbidity of the detergent compositions is preferably not more than 200 mg/L, more preferably not more than 150 mg/L, further more preferably not more than 120 mg/L, still further more preferably not more than 100 mg/L, and particularly preferably not more than 50 mg/L.

### Method for Measuring Kaolin Turbidity

A uniformly stirred sample (liquid detergent) is charged in 50-mm square cells with a thickness of 10 mm, and bubbles are removed therefrom. Then, the sample is measured for turbidity (kaolin turbidity: mg/L) at 25° C. with a turbidimeter (trade name: NDH2000, product of Nihon Denshoku Industries Co., Ltd.).

The polyalkylene glycol-based polymers according to the embodiments described above are outstandingly suitable as soil detachment-promoting additives for cleaning compositions such as laundry detergents, for example. It is of particular advantage that they display the soil-detaching power even at low washing temperatures.

The polyalkylene glycol-based polymers according to the embodiments described above can be added to the laundry detergents and cleaning compositions in amounts of generally from 0.05% to 10% by weight, from 0.1% to 15% by weight, preferably from 0.1% to 5% by weight, from 0.3% to 10% by weight, from 0.5% to 5% by weight, and more preferably from 0.25% to 2.5% by weight, based on the weight of the cleaning composition.

In addition, the laundry detergents and cleaning compositions generally comprise surfactants and, if appropriate, other polymers as washing substances, builders, and further customary ingredients, for example cobuilders, complexing agents, bleaches, standardizers, graying inhibitors, dye transfer inhibitors, enzymes and perfumes.

The polyalkylene glycol-based polymers described herein may be utilized in laundry detergents or cleaning compositions comprising a surfactant system comprising C₁₂-C₁₆ alkyl benzene sulfonates (LAS) and one or more co-surfactants selected from nonionic, cationic, anionic or mixtures thereof. Alternately, the multi-polymer system may be utilized in laundry detergents or cleaning compositions comprising surfactant systems comprising any anionic surfactant or mixture thereof with nonionic surfactants and/or fatty acids, optionally complemented by zwitterionic or so-called semi-polar surfactants such as the C₁₂-C₁₆ alkyldimethylamine N-oxides can also be used. In other embodiments, the surfactant used can be exclusively anionic or exclusively nonionic. Suitable surfactant levels are from about 0.5% to about 80% by weight of the detergent composition, more typically from about 5% to about 60% by weight.

A preferred class of anionic surfactants are the sodium, potassium and alkanolammonium salts of the C₁₂-C₁₆ alkylbenzenesulfonates which can be prepared by sulfonation (using SO₂ or SO₃) of alkylbenzenes followed by neutralization. Suitable alkylbenzene feedstocks can be made from olefins, paraffins or mixtures thereof using any suitable alkylation scheme, including sulfuric and HF-based processes. Any suitable catalyst may be used for the alkylation, including solid acid catalysts such as DETAL™ solid acid catalyst available commercially from UOP, a Honeywell company. Such solid acid catalysts include DETAL™ DA-114 catalyst and other solid acid catalysts described in patent applications to UOP, Petresa, Huntsman and others. It should be understood and appreciated that, by varying the precise alkylation catalyst, it is possible to widely vary the position of covalent attachment of benzene to an aliphatic hydrocarbon chain. Accordingly alkylbenzene sulfonates useful herein can vary widely in 2-phenyl isomer and/or internal isomer content.

The selection of co-surfactant may be dependent upon the desired benefit. In one embodiment, the co-surfactant is selected as a nonionic surfactant, preferably C₁₂-C₁₈ alkyl ethoxylates. In another embodiment, the co-surfactant is selected as an anionic surfactant, preferably C₁₀-C₁₈ alkyl alkoxy sulfates (AEₓS) wherein x is from 1 to 30. In another embodiment the co-surfactant is selected as a cationic surfactant, preferably dimethyl hydroxyethyl lauryl ammonium chloride. If the surfactant system comprises C₁₀-C₁₅ alkyl benzene sulfonates (LAS), the LAS is used at levels ranging from about 9% to about 25%, or from about 13% to about 25%, or from about 15% to about 23% by weight of the composition.

In one embodiment, the surfactant system may comprise from 0% to about 7%, or from about 0.1% to about 5%, or from about 1% to about 4% by weight of the composition of a co-surfactant selected from a nonionic co-surfactant, cationic co-surfactant, anionic co-surfactant and any mixture thereof.

Non-limiting examples of nonionic co-surfactants include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as PLURONIC® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x is from 1 to 30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408. Also useful herein as nonionic surfactants or co-surfactants are alkoxylated ester surfactants such as those having the formula R¹C(O)O(R²O)—R³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between 1 and 20. Such alkoxylated ester surfactants include the fatty methyl ester ethoxylates (MEE) and are well-known in the art; see for example U.S. Pat. No. 6,071,873; U.S. Pat. No. 6,319,887; U.S. Pat. No. 6,384,009; U.S. Pat. No. 5,753,606; WO 01/10391, WO 96/23049.

Non-limiting examples of semi-polar nonionic co-surfactants include: water-soluble amine oxides containing one alkyl moiety of from about 10 to about 18 carbon atoms and 2 moieties selected from the group consisting of alkyl moieties and hydroxyalkyl moieties containing from about 1 to about 3 carbon atoms; water-soluble phosphine oxides containing one alkyl moiety of from about 10 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. No. 4,681,704, and U.S. Pat. No. 4,133,779.

Non-limiting examples of cationic co-surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Nonlimiting examples of anionic co-surfactants useful herein include: C₁₀-C₂₀ primary, branched chain and random alkyl sulfates (AS); C₁₀-C₁₈ secondary (2,3) alkyl sulfates; C₁₀-C₁₈ alkyl alkoxy sulfates (AEₓS) where x is from 1 to 30; C₁₀-C₁₈ alkyl alkoxy carboxylates comprising from 1 to 5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242 and WO 99/05244; methyl ester sulfonate (MES); and alpha-olefin sulfonate (AOS). Anionic surfactants herein may be used in the form of their sodium, potassium or alkanolamine salts.

In example embodiments, cleaning compositions may comprise polyalkylene glycol-based polymers according to the embodiments described above, and also a surfactant system comprising C₈-C₁₈ linear alkyl sulphonate surfactant and a co-surfactant. The compositions can be in any form, namely, in the form of a liquid; a solid such as a powder, granules, agglomerate, paste, tablet, pouches, bar, gel; an emulsion; types delivered in dual-compartment containers; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a consumer; and other homogeneous or multiphase consumer cleaning product forms. The composition may alternatively be in the form of a tablet or pouch, including multi-compartment pouches.

In one embodiment, the cleaning composition may be a liquid or solid laundry detergent composition. In another embodiment, the cleaning composition may be a hard surface cleaning composition, preferably wherein the hard surface cleaning composition impregnates a nonwoven substrate. As used herein “impregnate” means that the hard surface cleaning composition is placed in contact with a nonwoven substrate such that at least a portion of the nonwoven substrate is penetrated by the hard surface cleaning composition, preferably the hard surface cleaning composition saturates the nonwoven substrate. The cleaning composition may also be utilized in car care compositions, for cleaning various surfaces such as hard wood, tile, ceramic, plastic, leather, metal, glass. This cleaning composition could be also designed to be used in a personal care and pet care compositions such as shampoo composition, body wash, liquid or solid soap and other cleaning composition in which surfactant comes into contact with free hardness and in all compositions that require hardness tolerant surfactant system, such as oil drilling compositions.

In another embodiment the cleaning composition is a dish cleaning composition, such as liquid hand dishwashing compositions, solid automatic dishwashing compositions, liquid automatic dishwashing compositions, and tab/unit dose forms of automatic dishwashing compositions.

Quite typically, cleaning compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials can be found in WO 99/05242.

Common cleaning adjuncts include builders, enzymes, polymers not discussed above, bleaches, bleach activators, catalytic materials and the like excluding any materials already defined hereinabove. Other cleaning adjuncts herein can include suds boosters, suds suppressors (antifoams) and the like, diverse active ingredients or specialized materials such as dispersant polymers (e.g., from BASF Corp. or Rohm & Haas) other than those described above, color speckles, silvercare, anti-tarnish and/or anti-corrosion agents, dyes, fillers, germicides, alkalinity sources, hydrotropes, anti-oxidants, enzyme stabilizing agents, pro-perfumes, perfumes, solubilizing agents, carriers, processing aids, pigments, and, for liquid formulations, solvents, chelating agents, dye transfer inhibiting agents, dispersants, brighteners, suds suppressors, dyes, structure elasticizing agents, fabric softeners, anti-abrasion agents, hydrotropes, processing aids, and other fabric care agents, surface and skin care agents. Suitable examples of such other cleaning adjuncts and levels of use are found in U.S. Pat. Nos. 5,576,282, 6,306,812 B1 and 6,326,348 B1.

### Methods of Use

Further embodiments may include a method for cleaning a targeted surface. As used herein “targeted surface” may include such surfaces such as fabric, dishes, glasses, and other cooking surfaces, hard surfaces, hair or skin. As used herein “hard surface” includes hard surfaces being found in a typical home such as hard wood, tile, ceramic, plastic, leather, metal, glass. Such method includes the steps of contacting the composition comprising the modified polyol compound, in neat form or diluted in wash liquor, with at least a portion of a targeted surface then optionally rinsing the targeted surface. Preferably the targeted surface is subjected to a washing step prior to the aforementioned optional rinsing step. As used herein, “washing” includes, but is not limited to, scrubbing, wiping and mechanical agitation.

As will be appreciated by one skilled in the art, the cleaning compositions described above are ideally suited for use in home care (hard surface cleaning compositions) and/or laundry applications.

The composition solution pH is chosen to be the most complimentary to a target surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

For use in laundry cleaning compositions, the compositions are preferably employed at concentrations from about 200 ppm to about 10000 ppm in solution (or wash liquor). The water temperatures preferably range from about 5° C. to about 60° C. The water to fabric ratio is preferably from about 1:1 to about 20:1.

The method may include the step of contacting a nonwoven substrate impregnated with an embodiment of the polymers or polymer compositions described herein. As used herein “nonwoven substrate” can comprise any conventionally fashioned nonwoven sheet or web having suitable basis weight, caliper (thickness), absorbency and strength characteristics. Examples of suitable commercially available nonwoven substrates include those marketed under the tradename SONTARA® by DuPont and POLYWEB® by James River Corp.

As will be appreciated by one skilled in the art, the cleaning compositions are ideally suited for use in liquid dish cleaning compositions. The method for using a liquid dish composition comprises the steps of contacting soiled dishes with an effective amount, typically from about 0.5 mL to about 20 mL (per 25 dishes being treated) of the liquid dish cleaning composition diluted in water.

Though particular embodiments of the present invention have been illustrated and described, it will be obvious to those skilled in the art that various other changes and modifications can be made without departing from the spirit and scope of the invention. It is therefore intended to cover in the appended claims all such changes and modifications that are within the scope of this invention.

### EXAMPLES

Hereinafter, the present invention is described in more detail based on examples. It will be understood that these Examples are meant to be illustrative only and not limiting with respect to the scope of the claims. All parts are by weight unless otherwise specified, and all percentages are by mass unless otherwise specified.

The monomers and intermediates were quantified and measured for various characteristic values by the methods described below.

The measurement conditions of weight-average molecular weight (M_{W}) and number-average molecular weight (M_{N}) using gel-permeation chromatography (GPC) are as follows:

Measuring device: L-7000 series (product of Hitachi Ltd.)

Detector: HITACHI RI Detector, L-7490

Column: SHODEX Asahipak GF-310-HQ, GF-710-HQ, GF-1G 7B (products of Showa Denko K. K.)

Column temperature: 40° C.

Flow velocity: 0.5 mL/min

Calibration curve: POLYETHYLENE GLYCOL STANDARD (product of GL Sciences, Inc.)

Eluant: 0.1 N sodium acetate/acetonitrile=3:1 mass ratio.

The carboxyl group-containing monomer and other compounds are quantified by liquid chromatography under the following conditions:

Measuring device: L-7000 series (product of Hitachi Ltd.)

Detector: UV detector, L-7400 (product of Hitachi Ltd.)

Column: SHODEX RSpak DE-413 (product of Showa Denko K. K.)

Temperature: 40.0° C.

Eluant: 0.1% phosphoric acid aqueous solution

Flow velocity: 1.0 mL/min

The polyalkylene glycol-based monomer is quantified by high-speed chromatography under the following conditions:

Measuring device: 8020 series (product of Tosoh Corp.)

Column: CAPCELL PAK C1 UG120 (product of Shiseido Co., Ltd.)

Temperature: 40.0° C.

Eluant: dodecahydrate solution of 10 mmol/L disodium hydrogen phosphate (pH 7 (controlled with phosphoric acid))/acetonitrile=45:55 volume ratio

Flow velocity: 1.0 mL/min

Detector: RI, UV (detection wavelength: 215 nm)

### Measurement of Solids Content

A mixture of 1.0 g of a polyalkylene glycol-based polymer composition containing the polyalkylene glycol-based polymer and 1.0 g of water is dried in an oven at 130° C. in nitrogen atmosphere for one hour. The solids content (%) and volatile component content (%) are calculated from the mass change before and after the drying step.

### Preparation of Polyalkylene Glycol-Based Polymers

### Example 1

In a 500-mL glass-separable flask equipped with a reflux condenser and a stirrer, pure water (58.6 g) and Mohr's salt (0.0017 g) are stirred while heating to 70° C. To the mixture, 80% acrylic acid aqueous solution (hereinafter, referred to as 80% AA) (65.0 g), 80% aqueous solution of propylene oxide (5-mol adduct of isoprenol-20-mol adduct of ethylene oxide, hereinafter referred to as 80% IPN20EO5PO) (43.3 g), 15% sodium persulfate (hereinafter, referred to as 15% NaPS) (25.0 g), and 15% sodium hydrogen sulfite (hereinafter, referred to as 15% SBS) (10.7 g) are separately added drop-wise through different openings.

The drop-wise addition times of 80% AA, 80% IPN20EO5PO, 15% NaPS, and 15% SBS are 180 minutes, 150 minutes, 190 minutes, and 180 minutes, respectively. The drop-wise addition of each solution is started at the same time. The temperature is controlled to 70° C. until the completion of drop-wise addition of 15% NaPS. The resulting solution is matured at the same controlled temperature for an additional 30 minutes after the completion of drop-wise addition of 15% NaPS and the polymerization is completed. After the completion of the polymerization, the reaction solution is left standing to be cooled and then is neutralized with 48% sodium hydroxide (hereinafter, referred to as 48% NaOH) (42.1 g). Through these steps, a copolymer composition (1) containing a copolymer (1) is prepared. The solids content of the copolymer composition (1) is 45%.

### Example 2

In a 500-mL glass separable flask equipped with a reflux condenser and a stirrer, pure water (72.0 g) and Mohr's salt (0.0025 g) are stirred while heating to 70° C. To the mixture, 80% AA (65.0 g), 80% IPN20EO5PO (97.5 g), 15% NaPS (26.1 g), and 15% SBS (52.3 g) are separately added dropwise through different openings. The drop-wise addition times of 80% AA, 80% IPN20EO5PO, 15% NaPS, and 15% SBS are 180 minutes, 150 minutes, 190 minutes, and 180 minutes, respectively.

The drop-wise addition of each solution is started at the same time. The temperature is controlled to 70° C. until the completion of drop-wise addition of 15% NaPS. The resulting solution is matured at the same controlled temperature for an additional 30 minutes after the completion of drop-wise addition of 15% NaPS, and the polymerization is completed. After the completion of the polymerization, the reaction solution is left standing to be cooled and then is neutralized with 48% NaOH (42.1 g). Through these steps, a copolymer composition (2) containing a copolymer (2) is prepared. The solids content of the copolymer composition (2) is 45%.

### Example 3

In a 500-mL glass separable flask equipped with a reflux condenser and a stirrer, 60% aqueous solution of propylene oxide (5 mol isoprenol adduct-10 mol ethylene oxide adduct, hereinafter referred to as 60% IPN10EO5PO) (28.0 g), and Mohr's salt (0.0060 g) are stirred while heating to 90° C. To the mixture, 80% AA (45.0 g), 60% IPN10EO5PO (112.0 g), 15% NaPS (41.1 g), 35% sodium hydrogen sulfite (hereinafter, referred to as 35% SBS) (3.5 g), and pure water (2.0 g) are separately added dropwise through different openings. The drop-wise addition times of 80% AA, 60% IPN10EO5PO, 15% NaPS, 35% SBS, and pure water are 180 minutes, 120 minutes, 210 minutes, 175 minutes, and 175 minutes, respectively.

The drop-wise addition of each solution is started at the same time. The temperature is controlled to 85° C. until the completion of drop-wise addition of 80% AA. The resulting solution is matured at the same controlled temperature for an additional 30 minutes after the completion of drop-wise addition of 15% NaPS, and the polymerization is completed. After the completion of the polymerization, the reaction solution is left standing to be cooled and then is neutralized with 48% NaOH (37.5 g) and pure water (5.2 g). Through these steps, a copolymer composition (3) containing a copolymer (3) is prepared. The solids content of the copolymer composition (3) is 50%.

### Example 4

In a 1000-mL glass separable flask equipped with a reflux condenser and a stirrer, pure water (169.2 g), 60% aqueous solution of propylene oxide (10 mol isoprenol adduct-40 mol ethylene oxide adduct (hereinafter, referred to as 60% IPN40EO10PO) (350.0 g), and Mohr's salt (0.0056 g) are stirred while heating to 90° C. To the mixture, 80% AA (112.5 g), 15% NaPS (35.6 g), and 35% SBS (30.5 g) are separately added dropwise through different openings. The drop-wise addition times of 80% AA, 15% NaPS, and 35% SBS are 180 minutes, 210 minutes, and 180 minutes, respectively.

The drop-wise addition of each solution is started at the same time. The temperature is controlled to 90° C. until the completion of drop-wise addition of 15% NaPS. The resulting solution is matured at the same controlled temperature for an additional 30 minutes after the completion of drop-wise addition of 15% NaPS, and the polymerization is completed. After the completion of the polymerization, the reaction solution is left standing to be cooled and then is neutralized with 48% NaOH (95.8 g). Through these steps, a copolymer composition (4) containing a copolymer (4) is prepared. The solids content of the copolymer composition (4) is 45%.

### Example 5

In a 500-mL glass separable flask equipped with a reflux condenser and a stirrer, pure water (24.0 g), 60% IPN10EO5PO (21.0 g), maleic acid (hereinafter, referred to as MA) (9.0 g), and Mohr's salt (0.0050 g) are stirred while heating to 90° C. To the mixture, 80% AA (22.5 g), 60% IPN10EO5PO (84.0 g), 15% NaPS (21.6 g), 35% SBS (0.6 g), and pure water (23.3 g) are separately added dropwise through different openings. The drop-wise addition times of 80% AA, 60% IPN10EO5PO, 15% NaPS, 35% SBS, and pure water are 180 minutes, 150 minutes, 210 minutes, 175 minutes, and 175 minutes, respectively.

The drop-wise addition of each solution is started at the same time. The temperature is controlled to 90° C. until the completion of drop-wise addition of 80% AA. The resulting solution is matured at the same controlled temperature for an additional 60 minutes after the completion of drop-wise addition of 15% NaPS, and the polymerization is completed. After the completion of the polymerization, the reaction solution is left standing to be cooled and then is neutralized with 48% NaOH (30.4 g). Through these steps, a copolymer composition (5) containing a copolymer (5) is prepared. The solids content of the copolymer composition (5) is 45%.

### Example 6

In a 500-mL glass separable flask equipped with a reflux condenser and a stirrer, pure water (2.2 g), 60% IPN10EO5PO (92.5 g), MA (16.0 g), and 35% hydrogen peroxide (0.4 g) are stirred while heating to 60° C. To the mixture, 1.5% aqueous solution of L-ascorbic acid (hereinafter, referred to as 1.5% L-AS) (12.5 g) is added dropwise over 60 minutes. The temperature is controlled to 60° C. until the completion of drop-wise addition of 1.5% L-AS. The resulting solution is matured at the same controlled temperature for an additional 60 minutes, and the polymerization is completed. After the completion of the polymerization, the reaction solution is left standing to be cooled and then is neutralized with 48% NaOH (20.7 g) and pure water (27.2 g). Through these steps, a copolymer composition (6) containing a copolymer (6) is prepared. The solids content of the copolymer composition (6) is 45%.

### Comparative Example 1

In a 500-mL glass separable flask equipped with a reflux condenser and a stirrer, pure water (34.4 g) and Mohr's salt (0.0013 g) were stirred while heating to 70° C. To the mixture, 80% AA (35.0 g), aqueous solution of 80% IPN25 (52.5 g), 15% NaPS (21.9 g), and 35% SBS (4.0 g) were separately added drop-wise through different openings. The drop-wise addition times of 80% AA, 80% IPN25, 15% NaPS, and 35% SBS were 180 minutes, 120 minutes, 190 minutes, and 180 minutes, respectively. The drop-wise addition of each solution was started at the same time. The temperature was controlled to 70° C. until the completion of drop-wise addition of 15% NaPS. The resulting solution was matured at the same controlled temperature for more 30 minutes after the completion of drop-wise addition of 15% NaPS, and the polymerization was completed. After the completion of the polymerization, the reaction solution was left standing to be cooled and then was neutralized with 48% NaOH (22.7 g). Through these steps, a comparative copolymer composition (1) containing a comparative copolymer (1) was prepared. The solids content of the comparative copolymer composition (1) was 45%.

### Comparative Example 2

In a 1000-mL glass separable flask equipped with a reflux condenser and a stirrer, pure water (169.2 g) and aqueous solution of 60% IPN50 (350.0 g), and Mohr's salt (0.0056 g) were stirred while heating to 90° C. To the mixture, 80% AA (112.5 g), 15% NaPS (35.8 g), and 35% SBS (30.7 g) were separately added drop-wise through different openings. The drop-wise addition times of 80% AA, 15% NaPS, and 35% SBS were 180 minutes, 210 minutes, and 180 minutes, respectively. The drop-wise addition of each solution was started at the same time. The temperature was controlled to 90° C. until the completion of drop-wise addition of 15% NaPS. The resulting solution was matured at the same controlled temperature for more 30 minutes after the completion of drop-wise addition of 15% NaPS, and the polymerization was completed. After the completion of the polymerization, the polymerization reaction solution was left standing to be cooled and then was neutralized with 48% NaOH (95.8 g). Through these steps, a comparative copolymer composition (2) containing a comparative copolymer (2) was prepared. The solids content of the comparative copolymer composition (2) was 45%.

### Copolymer Characterizations

The copolymer compositions (1) to (6) were analyzed by liquid chromatography to determine the amounts of the residual monomers, and the results revealed that the total amount of the residual monomers was less than 1000 ppm in each composition.

Compatibility with Surfactant

The copolymers (1) to (6) prepared in Examples 1 to 6 and the comparative copolymers (1) and (2) prepared in Comparative Examples (1) and (2) were evaluated for compatibility with surfactants as described below. TABLE 1 shows the results.

Detergent compositions each containing a test sample (polymer or polymer composition) are prepared using the following materials:

SFT-70H (polyoxyethylene alkyl ether, product of NIPPON SHOKUBAI Co., Ltd.): 40 g

NEOPELEX F-65 (sodium dodecylbenzene sulfonate, product of Kao Corp.): 7.7 g (active ingredient: 5 g)

Kohtamin 86W (stearyl trimethylammonium chloride, product of Kao Corp.): 17.9 g (active ingredient: 5 g)

Diethanolamine: 5 g

Ethanol: 5 g

Propylene glycol: 5 g

Test sample: 1.5 g (based on solids content)

Ion exchange water: balance to provide 100 g of detergent composition.

The mixture is sufficiently stirred so that all the components are uniformly dispersed. Turbidity (kaolin turbidity, mg/L) of the mixture is evaluated by turbidity measured at 25° C. with a turbidimeter (“NDH2000”, product of Nippon Denshoku Co., Ltd.).

The evaluation summarized in TABLE 1 is based on the following criteria:

Good: Kaolin turbidity of not less than 0 and less than 50 mg/L; phase separation, sedimentation, and turbidity were not visually observed.

Intermediate: Kaolin turbidity of not less than 50 mg/L and less than 200 mg/L; slight turbidity was visually observed.

Bad: Kaolin turbidity of not less than 200 mg/L; turbidity was visually observed.

TABLE 1
Surfactant compatibility of example copolymers

| | | | | Surfac- |
|---|---|---|---|---|
| | | | | tant |
| | | Composition | | Compat- |
| Example | Polymer | (wt. %) | M_{w} | ibility |
| Example 1 | copolymer (1) | IPN20EO5PO/AA | 11,000 | Good |
| | | 40/60 | | |
| Example 2 | copolymer (2) | IPN20EO5PO/AA | 9,000 | Good |
| | | 60/40 | | |
| Example 3 | copolymer (3) | IPN10EO5PO/AA | 10,000 | Good |
| | | 70/30 | | |
| Example 4 | copolymer (4) | IPN40EO10PO/AA | 26,000 | Good |
| | | 70/30 | | |
| Example 5 | copolymer (5) | IPN10EO5PO/AA/ | 10,000 | Good |
| | | MA | | |
| | | 70/20/10 | | |
| Example 6 | copolymer (6) | IPN10EO5PO/MA | 36,000 | Good |
| | | 78/22 | | |
| Comparative | comparative | IPN25/AA | 10,000 | Good |
| Example 1 | polymer (1) | 60/40 | | |
| Comparative | comparative | IPN50/AA | 20,000 | Good |
| Example 2 | polymer (2) | 70/30 | | |

### Anti-Soil Redeposition Ability Test

Anti-soil redposition ability is tested by the following procedure using JIS Z8901 Test Powders I Class 11 (typical analysis, 34.0-40.0 wt. % SiO₂, 26.0-32.0 wt. % Al₂O₃, 3.0-7.0 wt. % MgO, 17.0-23.0% Fe₂O₃, 0.0-3.0 wt. % CaO, 0.0-4.0 wt. % TiO₂, with particle sizes from less than 1 μm to about 8 μm):

(1) New white cotton cloth (Bleached, mercerized Cotton Twill as per ISO Doc 509 Series 6, Part 1, available from Testfabrics, Inc, 415 Delaware Avenue, PO Box #26, West Pittiston, Pa. 18643, USA), is cut into 5 cm×5 cm white cloths. The degree of whiteness is determined for the white cloths by measuring the reflectance with a colorimetric color difference meter (SE2000, product of Nippon Denshoku Industries Co., Ltd.).

(2) Deionized water (20 L) is added to calcium chloride dihydrate (5.88 g) such that hard water is prepared.

(3) Deionized water (100 mL) is added to sodium linear alkylbenzene sulfonate (8.0 g), sodium bicarbonate (9.5 g), and sodium sulfate (8.0 g) such that a surfactant aqueous solution is prepared. The pH is adjusted to 10.

(4) A terg-o-tometer (available from S. R. Lab Instruments, G-16, M. K. Industrial Premises Co-Op. Soc., Sonawala “X” Road No. 2, Goregaon (East), Mumbai—400 063 Maharashtra, India) is set at 25° C. Hard water (2 L), the surfactant aqueous solution (5 mL), 0.8% (based on solids content) test polymer aqueous solution (5 g), zeolite (0.30 g), and JIS test powders I Class 11 (1.0 g) (Japanese Industrial Standard powders, available from The Association of Powder Process Industry and Engineering, Kyoto JAPAN) are mixed, and are added to and stirred for one minute in each terg-o-tometer pot at 100 rpm. Subsequently, seven white cloths are put into each pot, and the mixture plus cloths are stirred for ten minutes at 100 rpm.

(5) Rinse Step. The original abovementioned wash water is discarded, the white cloths are wringed by hand, the cloths are returned into each terg-o-tometer pot, and then fresh hard water (2 L) at 25° C. is poured into each terg-o-tometer pot and stirred at 100 rpm for two minutes.

(6) The white clothes are ironed (at approximately 200° C.) with a cloth thereon to dry them while wrinkles are smoothed. The clothes are measured again for reflectance as whiteness with the colorimetric difference meter.

(7) The anti-soil redeposition ratio is determined from the following formula, based on the measurement results. Anti-soil redeposition ratio (%)=(whiteness of white cloth after washed)/(whiteness of original white cloth)×100. Data for selected copolymers are provided in TABLE 2.

TABLE 2
Anti-soil redeposition ratio of selected example copolymers

| | | Anti-Soil |
|---|---|---|
| | | Redeposition |
| Example | Polymer | Ability (%) |
| Example 2 | copolymer (2) | 59.6 |
| Example 5 | copolymer (5) | 60.7 |
| Comparative Example 1 | comparison polymer (1) | 57.9 |
| Comparative Example 2 | comparison polymer (2) | 59.0 |

The results of the Examples and Comparative Examples indicate a trend showing high compatibility with surfactants and high anti-soil redeposition ability in hard water of the polyalkylene glycol-based polymer comprising 1% to 90% by mass of the polyalkylene glycol-based structure units having formula (II) and 10 to 99% by mass of carboxyl structure units.

### Composition Formulations

### Example 7

### Granular Laundry Detergent

Examples of granular laundry detergents including the exemplified amphoteric polymers are provided in TABLE 3.

TABLE 3
Granular Laundry Detergent Compositions

| | A | B | C | D | E |
|---|---|---|---|---|---|
| Formula | Wt % | wt % | wt % | wt % | wt % |
| C₁₁₋₁₂ Linear alkyl benzene | 13-25 | 13-25 | 13-25 | 13-25 | 9-25 |
| sulphonate | | | | | |
| C₁₂₋₁₈ Ethoxylate Sulfate | — | — | 0-3 | — | 0-1 |
| C₁₄₋₁₅ alkyl ethoxylate (EO=7) | 0-3 | 0-3 | — | 0-5 | 0-3 |
| Dimethyl hydroxyethyl lauryl | — | — | 0-2 | 0-2 | 0-2 |
| ammonium chloride | | | | | |
| 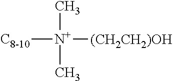 | | | | | |
| Sodium tripolyphosphate | 0-40 | — | 5-33 | 0-22 | 0-15 |
| Zeolite | 0-10 | 20-40 | 0-3 | — | — |
| Silicate builder | 0-10 | 0-10 | 0-10 | 0-10 | 0-10 |
| Carbonate | 0-30 | 0-30 | 0-30 | 5-25 | 0-20 |
| Diethylene triamine penta | 0-1 | 0-1 | 0-1 | 0-1 | 0-1 |
| acetate | | | | | |
| Polyacrylate | 0-3 | 0-3 | 0-3 | 0-3 | 0-3 |
| Carboxy Methyl Cellulose | 0.2-0.8 | 0.2-0.8 | 0.2-0.8 | 0.2-0.8 | 0.2-0.8 |
| Polymer¹ | 0.05-10 | 0.05-10 | 5.0 | 2.5 | 1.0 |
| Percarbonate | 0-10 | 0-10 | 0-10 | 0-10 | 0-10 |
| Nonanoyloxybenzenesulfonate | — | — | 0-2 | 0-2 | 0-2 |
| Tetraacetylethylenediamine | — | — | 0-0.6 | 0-0.6 | 0-0.6 |
| Zinc Phthalocyanine | — | — | 0-0.005 | 0-0.005 | 0-0.005 |
| Tetrasulfonate | | | | | |
| Brightener | 0.05-0.2 | 0.05-0.2 | 0.05-0.2 | 0.05-0.2 | 0.05-0.2 |
| MgSO₄ | — | — | 0-0.5 | 0-0.5 | 0-0.5 |
| Enzymes | 0-0.5 | 0-0.5 | 0-0.5 | 0-0.5 | 0-0.5 |
| Minors (perfume, dyes, suds | balance | balance | balance | balance | Balance |
| stabilizers) | | | | | |

¹A polyalkylene glycol-based polymer according to any of Examples 1-6, or a mixture containing two or more amphoteric polymers according to Examples 1-6.

### Example 8

### Liquid Laundry Detergents

Examples of liquid laundry detergent formulations comprising amphoteric polymers are provided in TABLES 4, 5, and 6.

TABLE 4
Liquid Laundry detergent formulations A-E

| | A | B | C | D | E |
|---|---|---|---|---|---|
| Ingredient | wt % | wt % | wt % | wt % | wt % |
| Sodium alkyl ether sulfate | 14.4% | — | 9.2% | 5.4% | — |
| Linear alkylbenzene sulfonic acid | 4.4% | 12.2% | 5.7% | 1.3% | — |
| Alkyl ethoxylate | 2.2% | 8.8% | 8.1% | 3.4% | — |
| Amine oxide | 0.7% | 1.5% | — | — | — |
| Citric acid | 2.0% | 3.4% | 1.9% | 1.0% | 1.6% |
| Fatty acid | 3.0% | 8.3% | — | — | 16.0% |
| Protease | 1.0% | 0.7% | 1.0% | — | 2.5% |
| Amylase | 0.2% | 0.2% | — | — | 0.3% |
| Lipase | — | — | 0.2% | — | — |
| Borax | 1.5% | 2.4% | 2.9% | — | — |
| Calcium and sodium formate | 0.2% | — | — | — | — |
| Formic acid | — | — | — | — | 1.1% |
| Polymer¹ | 1.8% | 2.1% | — | — | 3.2% |
| Sodium polyacrylate | — | — | — | 0.2% | — |
| Sodium polyacrylate copolymer | — | — | 0.6% | | — |
| DTPA² | 0.1% | — | — | — | 0.9% |
| DTPMP³ | — | 0.3% | — | — | — |
| EDTA⁴ | — | — | — | 0.1% | — |
| Fluorescent whitening agent | 0.15% | 0.2% | 0.12% | 0.12% | 0.2% |
| Ethanol | 2.5% | 1.4% | 1.5% | — | — |
| Propanediol | 6.6% | 4.9% | 4.0% | — | 15.7% |
| Sorbitol | — | — | 4.0% | — | — |
| Ethanolamine | 1.5% | 0.8% | 0.1% | — | 11.0% |
| Sodium hydroxide | 3.0% | 4.9% | 1.9% | 1.0% | — |
| Sodium cumene sulfonate | — | 2.0% | — | — | — |
| Silicone suds suppressor | — | 0.01% | — | — | — |
| Perfume | 0.3% | 0.7% | 0.3% | 0.4% | 0.6% |
| Opacifier⁵ | — | 0.30% | 0.20% | — | 0.50% |
| Water | balance | balance | balance | balance | balance |
| | 100.0% | 100.0% | 100.0% | 100.0% | 100.0% |

¹A polyalkylene glycol-based polymer according to any of Examples 1-6, or a mixture containing two or more amphoteric polymers according to Examples 1-6.
²diethylenetriaminepentaacetic acid, sodium salt
³diethylenetriaminepentakismethylenephosphonic acid, sodium salt
⁴ethylenediaminetetraacetic acid, sodium salt
⁵Acusol OP 301

TABLE 5
Liquid Laundry detergent formulations F-K

| | F | G | H | I | J | K |
|---|---|---|---|---|---|---|
| Ingredient | wt % | wt % | wt % | wt % | wt % | wt % |
| Alkylbenzene sulfonic | 7 | 7 | 4.5 | 1.2 | 1.5 | 12.5 |
| acid | | | | | | |
| Sodium C₁₂₋₁₄ alkyl | 2.3 | 2.3 | 4.5 | 4.5 | 7 | 18 |
| ethoxy 3 sulfate | | | | | | |
| C₁₄₋₁₅ alkyl 8-ethoxylate | 5 | 5 | 2.5 | 2.6 | 4.5 | 4 |
| C₁₂ alkyl dimethyl amine | — | 2 | — | — | — | — |
| oxide | | | | | | |
| C₁₂₋₁₄ alkyl hydroxyethyl | — | — | — | 0.5 | — | — |
| dimethyl ammonium | | | | | | |
| chloride | | | | | | |
| C₁₂₋₁₈ Fatty acid | 2.6 | 3 | 4 | 2.6 | 2.8 | 11 |
| Citric acid | 2.6 | 2 | 1.5 | 2 | 2.5 | 3.5 |
| Protease enzyme | 0.5 | 0.5 | 0.6 | 0.3 | 0.5 | 2 |
| Amylase enzyme | 0.1 | 0.1 | 0.15 | — | 0.05 | 0.5 |
| Mannanase enzyme | 0.05 | — | 0.05 | — | — | 0.1 |
| Alkoxylated | 1.0 | 0 | 1 | 0.4 | 1.5 | 2.7 |
| Polyalkylenimine | | | | | | |
| Polymer or alkoxylated | | | | | | |
| amine polymer | | | | | | |
| Polymer¹ | 0.5 | 1 | 1.5 | 2 | 1 | 0.8 |
| Diethylenetriaminepenta | 0.2 | 0.3 | — | — | 0.2 | — |
| (methylenephosphonic) | | | | | | |
| acid | | | | | | |
| Hydroxyethane | — | — | 0.45 | — | — | 1.5 |
| diphosphonic acid | | | | | | |
| FWA | 0.1 | 0.1 | 0.1 | — | — | 0.2 |
| Solvents (1,2-propanediol, | 3 | 4 | 1.5 | 1.5 | 2 | 4.3 |
| ethanol), stabilizers | | | | | | |
| Hydrogenated castor oil | 0.4 | 0.3 | 0.3 | 0.1 | 0.3 | — |
| derivative structurant | | | | | | |
| Boric acid | 1.5 | 2 | 2 | 1.5 | 1.5 | 0.5 |
| Na formate | — | — | — | 1 | — | — |
| Reversible protease | — | — | 0.002 | — | — | — |
| inhibitor³ | | | | | | |
| Perfume | 0.5 | 0.7 | 0.5 | 0.5 | 0.8 | 1.5 |

| | |
|---|---|
| Buffers (sodium | To pH 8.2 |
| hydroxide, | |
| Monoethanolamine) | |
| Water and minors | To 100 |
| (antifoam, aesthetics, . . .) | |

¹A polyalkylene glycol-based polymer according to any of Examples 1-6, or a mixture containing two or more amphoteric polymers according to Examples 1-6.

TABLE 6
Liquid Laundry Detergent Formulations L-Q

| | L | M | N | O | P | Q |
|---|---|---|---|---|---|---|
| Ingredient | wt % | wt % | wt % | wt % | wt % | wt % |
| Alkylbenzene sulfonic acid | 5.5 | 2.7 | 2.2 | 12.2 | 5.2 | 5.2 |
| Sodium C₁₂₋₁₄ alkyl ethoxy 3 | 16.5 | 20 | 9.5 | 7.7 | 1.8 | 1.8 |
| sulfate | | | | | | |
| Sodium C₁₂₋₁₄ alkyl sulfate | 8.9 | 6.5 | 2.9 | — | — | — |
| C₁₂₋₁₄ alkyl 7-ethoxylate | — | — | — | — | 0.15 | 0.15 |
| C₁₄₋₁₅ alkyl 8-ethoxylate | — | — | — | — | 3.5 | 3.5 |
| C₁₂₋₁₅ alkyl 9-ethoxylate | 1.7 | 0.8 | 0.3 | 18.1 | — | — |
| C₁₂₋₁₈ Fatty acid | 2.2 | 2.0 | — | 1.3 | 2.6 | 2.6 |
| Citric acid | 3.5 | 3.8 | 2.2 | 2.4 | 2.5 | 2.5 |
| Protease enzyme | 1.7 | 1.4 | 0.4 | — | 0.5 | 0.5 |
| Amylase enzyme | 0.4 | 0.3 | — | — | 0.1 | 0.1 |
| Mannanase enzyme | — | — | — | — | 0.04 | 0.04 |
| Alkoxylated | 2.1 | 1.2 | 1.0 | 2 | 1.00 | 0.25 |
| Polyalkylenimine Polymer or | | | | | | |
| alkoxylated amine polymer | | | | | | |
| Polymer¹ | 0.5 | 1 | 1.5 | 3.0 | 1 | 0.8 |
| PEG-PVAc Polymer² | — | — | — | — | — | 0.3 |
| Ethoxysulfated | — | — | — | — | 1 | 0.7 |
| Hexamethylene Diamine | | | | | | |
| Dimethyl Quat | | | | | | |
| Diethylenetriaminepenta | — | — | — | — | 0.2 | 0.2 |
| (methylenephosphonic) acid | | | | | | |
| FWA | — | — | — | — | .04 | .04 |
| Solvents (1,2-propanediol, | 7 | 7.2 | 3.6 | 3.7 | 1.9 | 1.9 |
| ethanol, stabilizers | | | | | | |
| Hydrogenated castor oil | 0.3 | 0.2 | 0.2 | 0.2 | 0.35 | 0.35 |
| derivative structurant | | | | | | |
| Polyacrylate | — | — | — | 0.1 | — | — |
| Polyacrylate copolymer³ | — | — | — | 0.5 | — | — |
| Sodium carbonate | — | — | — | 0.3 | — | — |
| Sodium silicate | — | — | — | — | — | — |
| Borax | 3 | 3 | 2 | 1.3 | — | — |
| Boric acid | 1.5 | 2 | 2 | 1.5 | 1.5 | 1.5 |
| Perfume | 0.5 | 0.5 | 0.5 | 0.8 | 0.5 | 0.5 |
| Buffers (sodium hydroxide, | — | — | — | — | 3.3 | 3.3 |
| monoethanolamine) | | | | | | |
| Water, dyes and | Balance | | | | | |
| miscellaneous | | | | | | |

¹A polyalkylene glycol-based polymer according to any of Examples 1-6, or a mixture containing two or more amphoteric polymers according to Examples 1-6.
²PEG-PVA graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.
³Alco 725 (styrene/acrylate)

### Example 9

### Liquid Dish Handwashing Detergents

Example liquid dish handwashing detergent formulations are provided in TABLE 7.

TABLE 7
Liquid Dish Handwashing Detergent Formulations

| Composition | A | B |
|---|---|---|
| C₁₂₋₁₃ Natural AE0.6S | 29.0 | 29.0 |
| C₁₀₋₁₄ mid-branched Amine Oxide | — | 6.0 |
| C₁₂₋₁₄ Linear Amine Oxide | 6.0 | — |
| SAFOL ® 23 Amine Oxide | 1.0 | 1.0 |
| C₁₁E₉ Nonionic² | 2.0 | 2.0 |
| Ethanol | 4.5 | 4.5 |
| Polymer¹ | 5.0 | 1.0 |
| Sodium cumene sulfonate | 1.6 | 1.6 |
| Polypropylene glycol 2000 | 0.8 | 0.8 |
| NaCl | 0.8 | 0.8 |
| 1,3 BAC Diamine³ | 0.5 | 0.5 |
| Suds boosting polymer⁴ | 0.2 | 0.2 |
| Water | Balance | Balance |

¹A polyalkylene glycol-based polymer according to any of Examples 1-6, or a mixture containing two or more amphoteric polymers according to Examples 1-6.
²Nonionic may be either C₁₁ Alkyl ethoxylated surfactant containing 9 ethoxy groups.
³1,3 BAC is 1,3 bis(methylamine)-cyclohexane.
⁴(N,N-dimethylamino)ethyl methacrylate homopolymer

### Example 10

### Automatic Dishwasher Detergent

Example automatic dishwasher detergent formulations are provided in TABLE 8.

TABLE 8
Automatic Dishwasher Detergent Formulations

| | A | B | C | D | E |
|---|---|---|---|---|---|
| Polymer dispersant² | 0.5 | 5 | 6 | 5 | 5 |
| Carbonate | 35 | 40 | 40 | 35-40 | 35-40 |
| Sodium | 0 | 6 | 10 | 0-10 | 0-10 |
| tripolyphosphate | | | | | |
| Silicate solids | 6 | 6 | 6 | 6 | 6 |
| Bleach and bleach | 4 | 4 | 4 | 4 | 4 |
| activators | | | | | |
| Polymer¹ | 0.05-10 | 1 | 2.5 | 5 | 10 |
| Enzymes | 0.3-0.6 | 0.3-0.6 | 0.3-0.6 | 0.3-0.6 | 0.3-0.6 |
| Disodium citrate | 0 | 0 | 0 | 2-20 | 0 |
| dihydrate | | | | | |
| Nonionic surfactant³ | 0 | 0 | 0 | 0 | 0.8-5 |
| Water, sulfate, | Balance | Balance | Balance | Balance | Balance |
| perfume, dyes and | to 100% | to 100% | to 100% | to 100% | to 100% |
| other adjuncts | | | | | |

¹A polyalkylene glycol-based polymer according to any of Examples 1-6, or a mixture containing two or more amphoteric polymers according to Examples 1-6.
²Such as ACUSOL ® 445N available from Rohm & Haas or ALCOSPERSE ® from Alco.
³Such as SLF-18 POLY TERGENT from the Olin Corporation.

### Example 11

### Liquid Laundry Detergent Composition in the Form of a Pouch, being Encapsulated by a Film of Polyvinyl Alcohol

Example Liquid laundry detergent compositions in pouches are provided in TABLE 9.

TABLE 9
Encapsulated Liquid Laundry Detergent Formulations

| | | B | | |
|---|---|---|---|---|
| | | 3 compartments | | |
| | A | pouched product | | |
| Compartment # | 1 | 1 | 2 | 3 |
| Dosage (g) | 36.0 | 34.0 | 3.5 | 3.5 |
| Ingredients | wt. % | wt. % | wt. % | wt. % |
| Alkylbenzene sulfonic acid | 14.5 | 14.5 | 20.0 | — |
| C₁₂₋₁₄ alkyl ethoxy 3 sulfate | 8.5 | 8.5 | — | — |
| C₁₂₋₁₄ alkyl 7-ethoxylate | 12.5 | 12.5 | 17.0 | — |
| C₁₂₋₁₈ Fatty acid | 14.5 | 14.5 | 13.0 | — |
| Protease enzyme | 1.5 | 1.5 | — | — |
| Amylase enzyme | 0.2 | — | — | — |
| Mannanase enzyme | 0.1 | — | — | — |
| PAP granule¹ | — | — | — | 50.0 |
| Polymer² | 1.5 | 2.0 | — | — |
| Ethoxysulfated Hexamethylene Diamine | 3.0 | — | 2.2 | — |
| Dimethyl Quat | | | | |
| PEG-PVAc Polymer³ | — | — | 2.5 | — |
| Hydroxyethane diphosphonic acid | 1.0 | 0.6 | 0.6 | — |
| Brightener | 0.2 | 0.2 | 0.2 | — |
| Solvents (1,2 propanediol, ethanol), | 20 | 20 | 25 | 30.0 |
| stabilizers | | | | |
| Hydrogenated castor oil derivative | 0.1 | — | 0.05 | — |
| structurant | | | | |
| Perfume | 1.8 | 1.7 | — | — |

| | |
|---|---|
| Buffers (sodium | To pH 8.0 for liquid |
| hydroxide, monoethanolamine) | |
| Water and minors (antioxidant, | To 100% |
| aesthetics, . . .) | |

¹PAP = Phthaloyl-Amino-Peroxycaproic acid, as a 70% active wet cake
²A polyalkylene glycol-based polymer according to any of Examples 1-6, or a mixture containing two or more amphoteric polymers according to Examples 1-6.
³PEG-PVA graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

“Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.”

“While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.”

All documents cited in the Detailed Description of the Invention are incorporated herein by reference. The citation of any document is not to be construed as an admission that it is prior art with respect to the present invention.

Unless otherwise defined, all technical and scientific terms used herein have the same meaning as commonly understood by one of ordinary skill in the art to which the invention belongs. The terminology used in the description herein is for describing particular embodiments only and is not intended to be limiting.

As used in the specification and appended claims, the singular forms “a,” “an,” and “the” are intended to include the plural forms as well, unless the context clearly indicates otherwise.

The term “independently selected from,” as used in the specification and appended claims, is intended to mean that the referenced groups can be the same, different, or a mixture thereof, unless the context clearly indicates otherwise. Thus, under this definition, the phrase “X¹, X², and X³ are independently selected from the group consisting of A, B, and C” would include the scenario where X¹, X², and X³ are all the same, where X¹, X², and X³ are all different, and where X¹ and X² are the same but X³ is different.

Though particular embodiments have been illustrated and described, it will be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising a polyalkylene glycol-based polymer, the polyalkylene glycol-based polymer formed from a plurality of structure units together defining a total mass, such that:
from 1% to 90% by mass of the plurality of structure units, based on the total mass, are polyalkylene glycol-based structure units having formula (II): 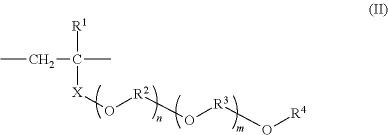
where:
R¹ is —H or —CH₃;
X is —CH₂—, —CH₂CH₂—, or a direct bond;
n is from 1 to 300 and represents an average addition number of moles of an oxyalkylene group (—R²—O—);
each R² is independently selected from C₂₋₂₀ alkylene groups;
m is from 1 to 20 and represents an average addition number of moles of an oxyalkylene group (—R³—O—);
each R³ is independently selected from C₃₋₄ alkylene groups; and
R⁴ is —H, a C₁₋₂₄ alkyl group, or a C₆₋₂₄ aryl group; and
from 10% to 99% by mass of the plurality of structure units, based on the total mass, are carboxyl structure units each derived from a carboxyl group-containing monomer.

2. The cleaning composition of claim 1, wherein:
from 5% to 40% by mass of the plurality of structure units, based on the total mass, are cationic-group structure units having formula (II); and
from 30% to 85% by mass of the plurality of structure units, based on the total mass of the plurality of structure units, are carboxyl structure units.

3. The cleaning composition of claim 1, wherein X is —CH₂CH₂— in each polyalkylene glycol-based structure unit.

4. The cleaning composition of claim 1, wherein from 80 mol. % to 100 mol % of the groups R² in each polyalkylene glycol-based structure unit are C₂ alkylene groups.

5. The cleaning composition of claim 1, wherein from 80 mol. % to 100 mol % of the groups R³ in each polyalkylene glycol-based structure unit are C₃ alkylene groups selected from the group consisting of isopropylene and isobutylene.

6. The cleaning composition of claim 1, wherein at least one structural unit is an additional structural unit not classified as a polyalkylene glycol-based structure unit or a carboxyl structure unit, and from greater than 0% to 60% by mass of the plurality of structure units, based on the total mass, are additional structural units.

7. The cleaning composition of claim 6, wherein the additional structure units are derived from monomers selected from the group consisting of sulfonic acid group-containing monomers, amino group-containing monomers, allylamine monomers, quaternized allylamine monomers, N-vinyl monomers, hydroxyl group-containing monomers, vinylaryl monomers, isobutylene monomers, vinyl acetate monomers, salts of any of these, derivatives of any of these, and mixtures thereof.

8. The cleaning composition of claim 1, wherein the polyalkylene glycol-based polymer has a weight-average molecular weight of from 2000 to 200,000.

9. The cleaning composition of claim 1, wherein the cleaning composition is selected from the group consisting of liquid laundry detergent compositions, solid laundry detergent compositions, hard surface cleaning compositions, liquid hand dishwashing compositions, solid automatic dishwashing compositions, liquid automatic dishwashing compositions, tab or unit-dose form automatic dishwashing compositions contained within a water-soluble pouch, and laundry detergent compositions contained within a water-soluble pouch.

10. The cleaning composition of claim 1, wherein the cleaning composition comprises from about 0.05% by weight to about 10% by weight of the polyalkylene glycol-based polymer, based on the total weight of the cleaning composition.

11. The cleaning composition of claim 1, further comprising a surfactant system.

12. The cleaning composition of claim 11, wherein the surfactant system comprises at least one C₁₂-C₁₆ alkyl benzene sulfonate surfactant.

13. The cleaning composition of claim 12, wherein the surfactant system further comprises one or more co-surfactant selected from the group consisting of nonionic surfactants, cationic surfactants, anionic surfactants, and mixtures thereof.

14. The cleaning composition of claim 11, wherein the surfactant system comprises at least one C₈-C₁₈ linear alkyl sulfonate surfactant.

15. The cleaning composition of claim 14, wherein the surfactant system further comprises one or more co-surfactant selected from the group consisting of nonionic surfactants, cationic surfactants, anionic surfactants, and mixtures thereof.

16. The cleaning composition of claim 15, further comprising one or more cleaning adjunct additives.

17. A cleaning implement comprising a nonwoven substrate and a cleaning composition according to claim 1.
